(19) United States
(12) Patent Application Publication
(10) Pub. No.: US 2018/0012307 A1
(43) Pub. Date: Jan. 11, 2018

(54) MOBILE POINT OF SALE SYSTEM WITH PHOTO SERVICE RECORDS AND MEDIA PUBLICATION

(71) Applicant: Facepay, Inc., San Jose, CA (US)

(72) Inventor: Mark Hale, San Jose, CA (US)

(21) Appl. No.: 15/643,717

(22) Filed: Jul. 7, 2017

Related U.S. Application Data
(60) Provisional application No. 62/359,375, filed on Jul. 7, 2016.

(51) Int. Cl. G06Q 50/00; G06F 17/30; G06Q 20/04; G06Q 20/20

(52) U.S. Cl. CPC G06Q 50/01; G06Q 20/202; G06F 17/30882; G06Q 20/0453

(57) ABSTRACT

Systems and methods are provided for a point of sale system that facilitates the development and maintenance of a photo-based record of goods sold or services rendered by the merchant to a consumer. The photo-based records can be beneficially utilized for multiple purposes, including, without limitation, one or more of: providing a historical record to the merchant of goods or services provided; capturing examples of goods or services provided for advertising and marketing purposes; providing consumers with photographic evidence of goods or services within an electronic receipt, potentially strengthening the customer's relationship with the merchant as well as supporting associated charges; enabling seamless, unobtrusive mechanisms for soliciting consumer releases and authorizations for use of the photographic record; and automating authorized publications of the photographic record, such as via posting to one or more social media platforms.

### TECHNICAL FIELD

The present disclosure relates in general to consumer transactions, and in particular to platforms, tools and methods that facilitate consumer transactions and manage customer relationships.

### BACKGROUND

Providers of consumer goods and services increasingly utilize electronic platforms for numerous functions, including tracking consumer transactions and processing payments. Such businesses typically place great value on capabilities that help strengthen their customer relationships and/or streamline business workflows.

Point of sale and payment systems are often used to conduct payment transactions with consumers. Traditional point of sale systems generate paper receipts for customers, and maintain electronic transaction records. Newer point of sale systems and/or payment systems may include features enabling electronic customer receipts, such as receipts sent via email or SMS. In some circumstances, customers may be prompted to enter their electronic contact address at the point of sale. In some circumstances, an electronic contact address may be pre-associated with a particular form of payment presented. In yet other circumstances, transactions may be linked to customer accounts for which a notification address is configured. In any case, the receipt typically specifies a text description of the goods or services provided, and an amount of the transaction. Some services, such as Uber™, provide email receipts with supplemental information about a transaction, such as a map showing the route traveled. Other services, such as Square™, provide email receipts with a graphic map showing the location at which a transaction took place.

Meanwhile, providers of consumer goods and services increasingly rely on Internet-based communications channels, such as social media, to advertise and develop relationships with their current and target customers. But developing and maintaining an active social media presence may be difficult and time-consuming, particularly for sole proprietors and other small businesses that may not have sufficient scale to hire staff specifically for that role. Therefore, it may be highly desirable to facilitate social media activity with little or no added effort on the part of the business.

### SUMMARY

A merchant may implement a point of sale system that facilitates the development and maintenance of a photo-based record of goods sold or services rendered by the merchant to a consumer, as well as providing customers with information-rich and interactive electronic receipts. The photo-based records can be beneficially utilized for multiple purposes, including, without limitation, one or more of: (1) providing a historical record to the merchant of goods or services provided; (2) capturing examples of goods or services provided for advertising and marketing purposes; (3) providing consumers with photographic evidence of goods or services within an electronic receipt, potentially strengthening the customer's relationship with the merchant as well as supporting associated charges; (4) enabling seamless, unobtrusive mechanisms for soliciting consumer releases and authorizations for use of the photographic record; and (5) automating authorized publications of the photographic record, such as via posting to a merchant's social media account.

For example, in accordance with some embodiments, a method is provided for a point of sale transaction system to publish content from a photographic record of a commercial transaction via a social media platform. The method may include capturing a digital photograph associated with the commercial transaction using a point of sale computing device having a digital camera associated therewith, such as a tablet computer of mobile phone. The digital photograph may be stored locally on the point of sale computing device, and/or transmitted to a network-connected server for storage. A transaction receipt for the commercial transaction may be electronically transmitted to a customer communication address (such as an email address) of a customer associated with the transaction. The receipt may include identification of a merchant involved in the transaction, a description of goods sold and/or services rendered in the transaction, and a customer authorization query enabling customer conveyance of authorization to publish the digital photograph (e.g. via a social media account associated with the merchant or another party involved with the transaction). The customer authorization query may be, e.g., a text-based hyperlink, or an image-based authorization indicium such as a HTML <img> tag with an href attribute. A positive response to the customer authorization query may be received, such as via transmission of a digital communication responsive to selection of the customer authorization query by a recipient of the electronic transaction receipt. Content including the digital photograph may then be transmitted to a social media platform for publication thereon. A social media post containing the digital photograph may, in some embodiments, be generated automatically by a publishing computing system, such as via use of predetermined templates created by or for a merchant involved in the transaction with which the digital photograph is associated.

Details of these and other aspects of the disclosed embodiments are described in further detail herein.

### BRIEF DESCRIPTION OF THE DRAWINGS

FIG. 1 is a schematic block diagram of a computing environment that may be used in some embodiments.

FIG. 2 is a schematic block diagram of a mobile device that can serve as a merchant point-of-sale device.

FIG. 3 diagram of a process for capturing photographic transaction records, providing information-rich and interactive customer receipts and soliciting customer authorizations.

FIG. 4 is a schematic block diagram of a point-of-sale system user interface.

FIG. 5 is a schematic block diagram of an electronic receipt.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Computing Environment

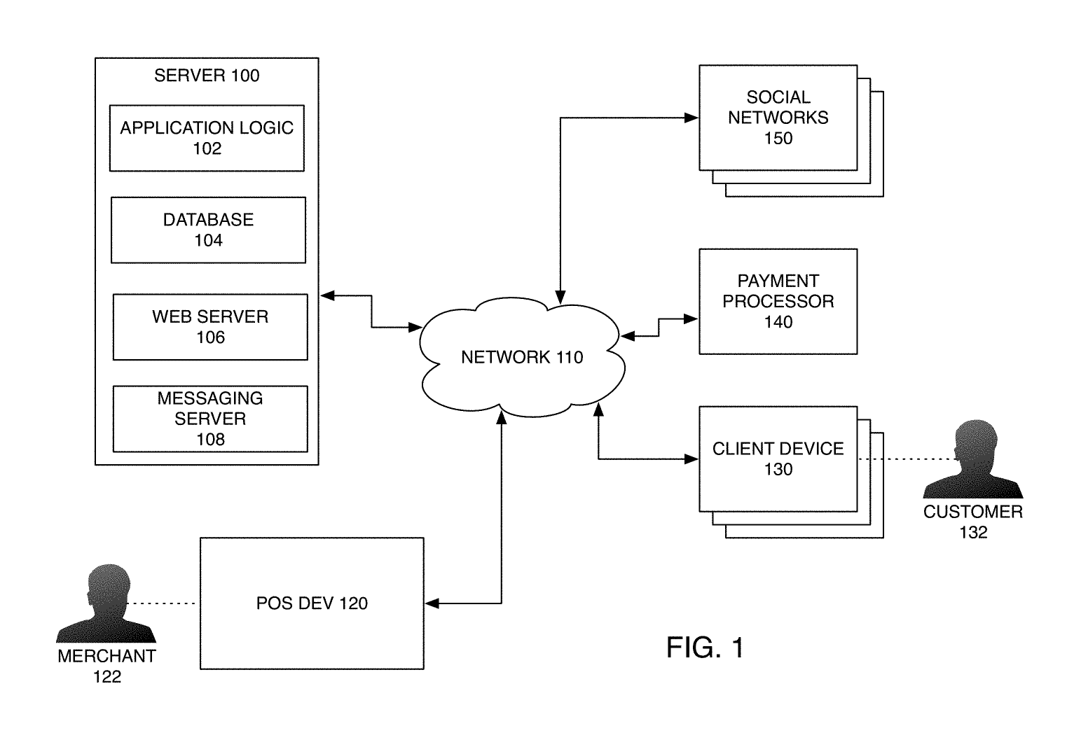

FIG. 1 is schematic block diagram of a computing environment that may be utilized to implement certain embodiments of the systems and methods described herein. Server 100 communicates, inter alia, via computer network 110, which may include the Internet, with: point of sale device 120, which is preferably a smartphone or tablet computer; client devices 130 (which may include, without limitation: smartphones, tablet computers, laptop computers, desktop computers, smart glasses, smart watches, smart appliances and other mobile or installed electronic devices featuring microprocessors, user interface mechanisms and networked data communications capabilities); payment processor 140 and social network services 150.

Server 100 implements application logic 102, and operates to store information within, and retrieve information from, database 104. The term “database” is used herein broadly to refer to a store of data, whether structured or not, including without limitation relational databases and document databases. Web server 106 hosts one or more Internet web sites enabling outside user interaction with, amongst other things, application logic 102 and database 104. Messaging server 108 enables electronic messaging, such as email, SMS and/or MMS communications, between server 100 and devices 120 and 130.

While depicted in the schematic block diagram of FIG. 1 as a block element with specific sub-elements, as known in the art of modern web applications and network services, server 100 and its associated functionality may be implemented in a variety of ways, including via distributed hardware and software resources and using any of multiple different software stacks. Server 100 may include a variety of physical, functional and/or logical components such as one or more each of web servers, application servers, database servers, email servers, storage servers, SMS or other instant messaging servers, and the like. That said, implementations of server 100, point of sale device 120, client devices 130, payment processor 140 and social network services 150 will typically include at some level one or more physical computers having one or more microprocessors and digital memory for, inter alia, storing instructions which, when executed by the processor, cause the computer to perform components of the methods and operations described herein.

Social networks 150 include one or more social media and online communication platforms, such as Instagram™, Yelp™, LinkedIn™, Twitter™, SnapChat™, WeChat™ or WhatsApp™. Interactions with social networks 150 may take place via APIs, messaging protocols, application handoff, or other mechanisms, as is known in the art.

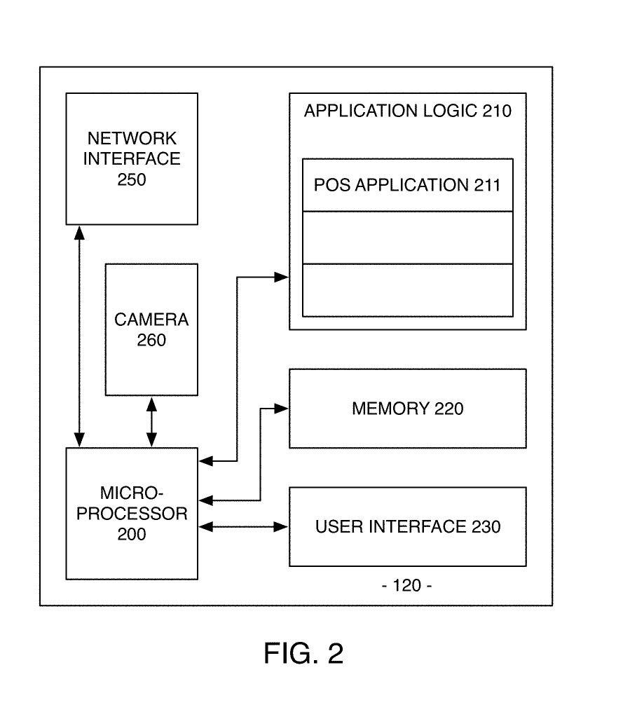

FIG. 2 is a schematic block diagram of an exemplary mobile computing device that may be used as POS device 120. POS device 120 includes microprocessor-based controller 200, application logic 210, digital memory 220, user interface components 230, network interface 250, and digital camera module 260. User interface components 230 may include a touch-sensitive display screen, as is typical of a smartphone or tablet computer. Microprocessor 200 implements application logic 210 to interact with user interface components 230, camera 260 and network interface 250, and to perform various functions described further elsewhere herein. Devices analogous to the mobile computing device of FIG. 2 (although typically having differing application logic) may be utilized by customers or clients as client devices 130.

Point of Sale System with Electronic Photo Receipts

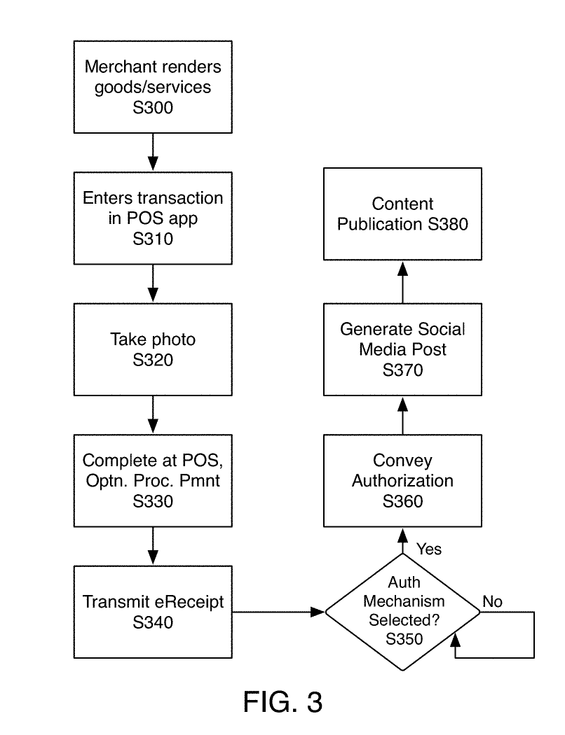

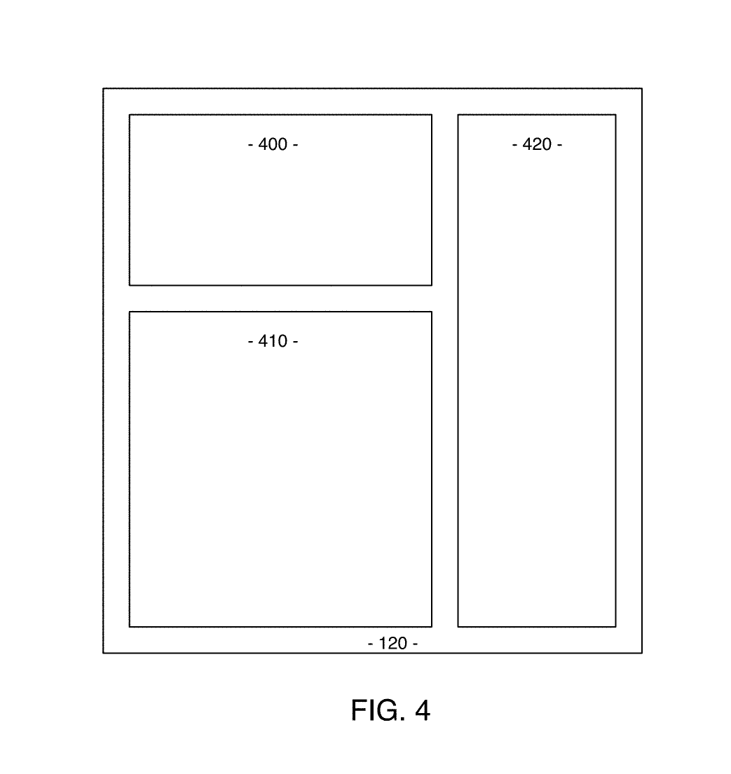

FIG. 3 is a process diagram illustrating an exemplary mode of operation for the computing environment participants of FIG. 1, and the POS device of FIG. 2. In step S300, merchant 122 conducts a business transaction with consumer 132, such as selling goods or rendering services. In step S310, merchant 122 utilizes POS device 130 to record transaction details using POS application 211. FIG. 4 is a schematic illustration of an exemplary user interface that may be rendered on a display screen associated with POS device 130, to enable recording of transaction details in step S310. Customer selection region 400 enables merchant 122 to select a customer with which a transaction is associated. In some embodiments, a customer may be selected from amongst a plurality of known customer accounts. In other embodiments, a customer may be identified automatically by, e.g., associating a customer account with a payment method presented for payment at POS device 130 (e.g. a previously-supplied credit card, debit card, loyalty card, or proximity devices such as RFID, NFC, Cellular or other Wireless electronic devices). In yet other embodiments, a customer may be initially unidentified or identified as a new customer, and subsequently associated with a customer account based on, e.g., name, presented payment method, or other identifying information. At some point, an electronic communication address may be associated with a customer for transmission of electronic receipts, such as specification of an email address, mobile phone number for text messaging, or communication application user ID.

Region 410 enables specification of transaction details. For example, a service provider may populate a selection of possible services that are available for rendering, and associated prices, such that indicia indicative of one or more services may be selected by merchant 122 for inclusion in a transaction. Selected goods or services are then rendered in a transaction detail display within transaction detail region 420. Transaction detail region 420 may include, inter alia, specification of the goods or serviced provided in connection with a transaction, associated pricing information, and a total transaction price.

In step S320, merchant 122 takes a photograph for association with the present transaction. To the extent that point of sale device 120 includes an integrated digital camera 260 (such as a typical mobile phone or tablet computer) or a digital camera otherwise associated with device 120, the camera can be used to photograph goods supplied, or services rendered, at the time and location of the transaction. For example, a hair stylist may photograph his or her customer's hair after the completion of services rendered. The photograph taken in step S320 is preferably stored locally within POS device 120 (e.g. within memory 220), and also uploaded to server 100 via network 110 for storage in, e.g., database 104.

In step S330, the transaction is completed at the Point of Sale, e.g. via the user interface of FIG. 4. In some embodiments, payment can be processed, such as via interaction of POS device 120 with payment processor 140. In other embodiments, the transaction may be cashless or account-billed, in which case the Point of Sale completion may be primary utilized to generate transaction records, and any associated billing may occur later.

The photographic transaction records captured in step S320 may be utilized for multiple purposes. For example, in a service provider context such as hair stylist, merchant 122 can look up visual records of prior services rendered in order to refresh their recollection prior to a subsequent appointment with a recurring client. In the event of a dispute over the nature of services rendered or goods provided, merchant 122 can use the photographic record as evidence of the nature of prior transactions. Such evidence may be particularly valuable in transaction environments in which a customer implicitly authorizes a charge, such as a card on file or card-not-present credit card transaction to a credit card for which information is maintained by the merchant on file or with a customer pre-authorization. To that end, photographic transaction records captured in step S320 are preferably stored (e.g. within server 100 database 104 and optionally locally within POS device 120) and associated with a customer profile, for convenient search and recall of historical transaction records.

The photographic record captured in step S320 may also be used to prepare and transmit information-rich electronic receipts to a customer via an electronic communication address associated with the customer, with the receipt potentially including interactive customer queries, as further described hereinbelow. In step S340, an electronic receipt is transmitted to customer 132, for viewing using client device 130. In some embodiments, the electronic receipt is transmitted via email. In other embodiments, an electronic receipt may be transmitted (additionally or alternatively) to other customer communication addresses via, e.g., SMS text message, Yahoo Messenger™, WeChat™, WhatsApp™, or other electronic communication mechanisms.

For example, POS device 120 can communicate details concerning a completed transaction to server 100; in response, application logic 102 causes messaging server 108 to transmit an email to an email address associated with customer 132. Additionally or alternatively, information-rich receipts bearing the photographic record captured in step S320 may be printed for the customer (at the time of the transaction or subsequently), and provided to the customer by the merchant (e.g. handed to the customer at the time of the transaction, or mailed to the customer via postal service).

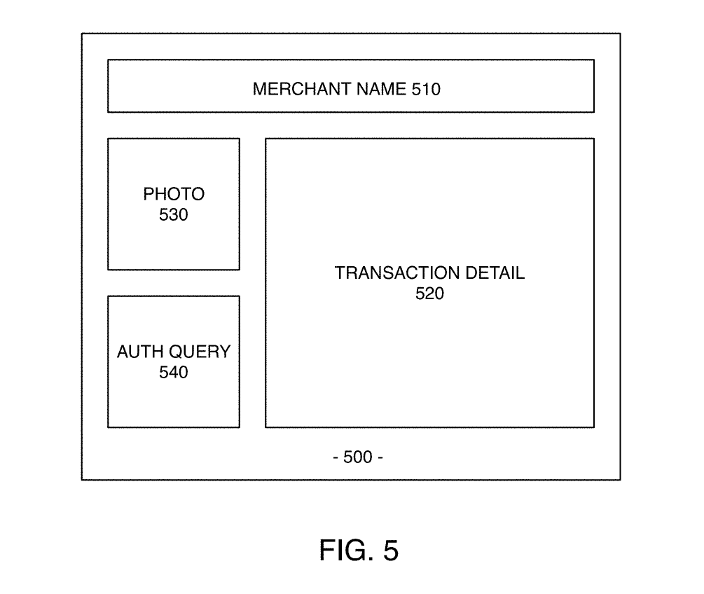

FIG. 5 is a schematic representation of an electronic receipt 500, as transmitted in step S340 and subsequently rendered on client device 130. In some embodiments, electronic receipt 500 may be rendered directly upon viewing of a message by a user; for example, electronic receipt 500 may be an HTML-based email that is rendered directly within an email client running on client device 130. In some embodiments, electronic receipt 500 may be rendered in response to activation of a message notification; for example, an SMS message may include a hyperlink that can be selected to render some or all portions of electronic receipt 500 within a web browser, in addition to or in lieu of rendering receipt content within the SMS message itself. Alternatively, a mobile messaging application notification may be selected to render electronic receipt 500 on a display screen associated with customer device 130.

Region 510 identifies merchant 122. Region 520 provides transaction detail, such as goods provided, services rendered, and associated charges.

Region 530 contains the photograph taken during step S320. Photograph region 530 can provide a visual record of the transaction. Inclusion of photograph region 530 directly within electronic receipt 500 can provide many benefits to the merchant and customer alike. For example, the contents of photograph region 530 can remind a customer of the nature of the services rendered or goods procured, thereby hopefully reinforcing a customer's positive feelings surrounding a transaction, and reducing risk of customer-initiated chargebacks for transactions that would not otherwise be identified by the customer.

Another benefit of electronic receipts 500 and associated photograph region 530 is that receipts 500 can be easily stored by customer 132, to maintain a photographic record of prior transactions that can be easily searched and recalled. For example, in the context of a hair stylist merchant, a customer can easily recall a record of prior hair styles for purposes of comment and comparison during subsequent rendering of hair styling services.

Electronic receipt 500 additionally includes customer authorization query region 540. Query region 540 includes a query mechanism by which customer 132 can provide, e.g., feedback or authorizations relating to the transaction. In some embodiments, authorization query region 540 can include a request for customer 132 to authorize merchant 122 to post the photograph contained in region 530 on merchant social media accounts and online platforms, such as Instagram, Yelp, Snapchat, LinkedIn, Twitter, WeChat, WhatsApp and the merchant's web site. In some embodiments, authorization query region 540 can include a request for customer 132 to provide a blanket authorization to publish customer photos or other content to social media and online platforms.

In step S350, a determination is made as to whether the recipient of electronic receipt 500 has responded affirmatively to a query within authorization query region 540. For example, a button indicium may be included in authorization query region 540. In some embodiments, the button indicium may be rendered via a Hypertext Markup Language (“HTML”)<img> tag with an href attribute, the href attribute having a Uniform Resource Locator (“URL”) directed to server 100. Selection of the button indicium in step S350 by the recipient of electronic receipt 500 (e.g. by tapping or clicking on the button using customer device 130) would convey the requested positive authorization communication back to server 100 (step S360). In some embodiments, negative responses may also be queried and received. Preferably, responses received by server 100 in step S350 and S360 are associated with the transaction and/or responding customer and stored within database 104 to maintain authorization records that can be subsequently queried or otherwise acted upon.

In step S370, server 100 receives the authorization indicium from step S360 and responds by generating one or more content publications, such as social media posts, typically including the photograph content that was rendered in region 540 and possibly other information relating to the transaction, such as identification of services rendered or goods supplied. In some embodiments, publication content may be generated automatically in step S370 and based on predetermined or templated content specified by merchant 122. In step S380, the content publications generated in step S370 are automatically disseminated by server 100, such as via publication to social media service APIs utilizing prior posting authorization provided by merchant 122, for posting on a social media account associated with merchant 122.

While in some embodiments, the digital photograph may be published to a social media account and/or web site associated with a merchant involved in the transaction for which the photograph was taken, in other embodiments, it may be desirable to publish the digital photograph by other systems or by other entities. For example, in some embodiments, it may be desirable to utilize the systems and processes described herein to obtain content and authorization for publication by multiple individuals and/or entities, or via multiple platforms. For example, a product manufacturer may wish the publish the photograph, in addition to or in lieu of the merchant. In some such embodiments, point of sale device 120 will associate a transaction (and a digital photograph taken in connection therewith) with one or more entities based at least in part on other information captured in the transaction, such as the identity of items purchased. The customer authorization query transmitted in an electronic receipt in step S340 may then include a query for authorization for the product manufacturer to publish the photograph on social media accounts associated with the manufacturer. For example, in step S320, a car dealer may take a photograph of a customer standing next to a newly-purchased vehicle; the electronic receipt transmitted in step S340 may then include a customer authorization query, selection of which authorizes both the car dealership and the car manufacturer involved in the transaction to use the photograph, such as via publication on a web site and/or social media account.

While the process of FIG. 3 contemplates customers being queried for authorization to use a photo after the transaction, via an electronic receipt, in other use cases, customers may be asked to provide authorization to publish a photo record at the time of the transaction (e.g. in step S310, S320 or S330), or beforehand (e.g. by providing a blanket authorization to use customer photos in a first transaction, which applies to subsequent transactions). In some such cases, the authorization check steps S350 and S360 may additionally or alternatively query records of prior authorizations to determine whether a photographic record procured in step S320 may be published. Moreover, where a customer provides prior authorization to publish a photographic record, the authorization query region 540 of electronic receipt 500 may comprise a link, icon, control, or other user interface mechanism enabling a customer to revoke a prior or blanket authorization, or otherwise modify their customer preferences relative to the systems described herein.

By implementing systems and processes such as those described herein, merchants and others can seamlessly and conveniently maintain a historical photographic record of customer transactions, provide customers with a rich and technologically-sophisticated buying experience, and continually drive social media and other marketing content with little or no added ongoing effort by the merchant.

### Serverless Embodiments

Preferably, cloud server 100 interacts with merchant POS device 120 to enable functionality that is independent of a particular local electronic device. In such embodiments, data is maintained on server 100, and numerous operations are performed by server 100, such that merchant 122 can power down or replace device 120 without disrupting the above-described merchant services. However, it is understood that some or all of the functionality and/or operational components described above as being implemented on server 100, could alternatively be implemented locally by POS device 120, thereby enabling embodiments that are serverless or that feature reduced reliance on server 100.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or any appended claims.

1. A method for a point of sale transaction system to publish content from a photographic record of a commercial transaction via a social media platform, the method comprising:
capturing a digital photograph associated with the commercial transaction using a point of sale computing device having a digital camera associated therewith;
electronically transmitting a transaction receipt for the commercial transaction to a customer communication address of a customer associated with the transaction, the receipt comprising a customer authorization query enabling customer conveyance of authorization to publication of the digital photograph;
receiving a positive response to the customer authorization query; and
transmitting content comprising the digital photograph to a social media platform for publication thereon.

2. The method of claim 1, in which the point of sale computing device is a tablet computer having an integrated digital camera.

3. The method of claim 1, in which the transaction receipt further comprises:
identification of a merchant associated with the transaction; and a description of goods sold and/or services rendered in the transaction.

4. The method of claim 1, in which the customer authorization query comprises a hyperlink.

5. The method of claim 1, in which the customer authorization query comprises an approval button.

6. The method of claim 1, in which the customer authorization query enables customer conveyance of blanket authorization to publication of digital photographs of a customer.

7. The method of claim 1, in which the step of receiving a positive response to the customer authorization query comprises: receiving, by a network-connected server, a digital communication responsive to selection of the customer authorization query by a recipient of the electronic transaction receipt.

8. The method of claim 1, in which the step of capturing a digital photograph comprises the substeps of: transmitting the digital photograph from the point of sale computing device to a network-connected server via a digital communications network; and storing the digital photograph by the network-connected server.

9. The method of claim 1, in which the step of transmitting content comprising the digital photograph to a social media platform for publication thereon comprises the substeps of: automatically generating a social media post comprising predetermined content and the digital photograph; and transmitting the social media post to a social media account associated with a user of the point of sale system.

10. The method of claim 1, in which the customer authorization query further enables customer conveyance of blanket authorization for publication of digital photographs.

11. The method of claim 1, in which the customer authorization query further enables revocation of prior authorization for publication of digital photographs.

12. A method for a point of sale transaction system to publish content from a photographic record of a commercial transaction via a social media platform, the method comprising:
capturing a digital photograph associated with the commercial transaction using a point of sale computing device having a digital camera associated therewith;
generating a transaction receipt for the commercial transaction, the receipt comprising the digital photograph;
querying the customer for authorization to publish the digital photograph; and
transmitting content comprising the digital photograph to an online content publication platform for publication thereon.

13. The method of claim 12, in which the step of querying the customer for authorization to publish the digital photograph is performed at the time of the commercial transaction.

14. The method of claim 12, in which the step of querying the customer for authorization to publish the digital photograph comprises:
electronically transmitting a transaction receipt for the commercial transaction to a customer communication address of a customer associated with the transaction, the receipt comprising the digital photograph and a customer authorization query enabling customer conveyance of authorization to publication of the digital photograph; and
receiving a positive response to the customer authorization query.

15. The method of claim 12, in which the online content publication platform is a social media service.

16. The method of claim 12, in which the step of generating a transaction receipt for the commercial transaction comprises: electronically transmitting a transaction receipt for the commercial transaction to a customer communication address of a customer associated with the transaction, the receipt comprising the digital photograph and a customer authorization query enabling revocation of prior authorization to publish the digital photograph.
